(19) United States
(12) Patent Application Publication
(10) Pub. No.: US 2005/0047420 A1
(43) Pub. Date: Mar. 3, 2005

(54) Mobile IPv6 network having multiple home agents and method of load balance

(76) Inventors: Shiro Tanabe, Hidaka (JP); Xiao Long Huang, Beijing (CN); Hui Deng, Beijing (CN); Kai Zhang, Beijing (CN); Zhisheng Niu, Beijing (CN)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/880,650

(22) Filed: Jul. 1, 2004

(30) Foreign Application Priority Data
Jul. 1, 2003 (CN) 03145741.X

(51) Int. Cl. H04L 12/56

(52) U.S. Cl. 370/395.52

(57) ABSTRACT

In a mobile IPv6 network having multiple distributed regression home agents and a load balance method for the multiple regression home agents, the network comprises a plurality of mobile subnets connected to each other through an Internet. Each mobile subnet comprises an access router, a plurality of mobile nodes, and a plurality of regression agents. The regression agents are arranged in a distributed topology structure. The regression agents exchange information with each other by performing a broadcast of traffic load information (table) among the regression agents. Further, each of the regression agents has a traffic load table to perform the load balance operation accordingly.

### CROSS-REFERENCE TO RELATED APPLICATION

The present application claims priority from Chinese patent application No. 03145741.X filed on Jul. 1, 2003, the content of which is hereby incorporated by reference into this application.

### BACKGROUND OF THE INVENTION

The invention relates in general to a mobile IPv6 communication technology. More specifically, the present invention relates to a mobile IPv6 network having multiple distributed regression home agents and a load balance method for the multiple distributed regression home agents. It mainly uses registered mobile node information and traffic information in the mobile IPv6 network to share the traffic load of the regression agents.

Recently, many researches relate to how to combine the wireless communication and the Internet. The mobile IPv6 standard (Mobility support in IPv6 <Draft-ietf-mobileip-ipv6-23>, 2003), proposed by D. B. Johnson, C. Perkins and J. Arkko in IETF, is considered to be an important technology for implementing the integrated wireless communication and the seamless communication of a wired network. In the mobile IPv6, when a mobile node is away from the regression network, there should be a regression agent to maintain registered information of the mobile node. The regression agent represents an IP datagram that the mobile node catches and transmits to the registered mobile node and packs and transmits to the mobile node. When the number of the mobile nodes serviced by the regression agent increases significantly, the datagram will be queued at the regression agent, causing a long delay and a long registration process. Under a fixed traffic, for example, in the mobile IPv6 network supporting multimedia applications and having multiple mobile nodes, since the regression agent has to bear many packet tunnel datagrams, the regression agent becomes a traffic bottleneck. In general, the traffic bottleneck causes delays. More seriously, it causes breakdown of the regression agent.

In the mobile IPv4 network, there are several methods proposed to solve the aforementioned problems. However, their research objects are to use numerical results of their analysis models, rather than to implement a technology in connection with a real mobile IPv6. Therefore, they are restricted and limited. At the same time, these results are not very sensitive to changes of unimportant parameters. These methods cannot previously prevent the occurrence of traffic load bottleneck phenomenon.

All of the aforementioned methods ignore preventing the occurrence of traffic load bottleneck in advance and how to be implemented with the IETF (International Engineering Technology Force) mobile IP standard. Namely, these methods are only analysis models and away from real situation. Eventually, they seldom consider the situation of the mobile IPv6.

### SUMMARY OF THE INVENTION

According to the foregoing description, an object of this invention is to provide an IPv6 network having multiple distributed regression home agents and a load balance method for the multiple regression home agents.

An IPv6 network having multiple distributed regression home agents according to the present invention, which includes a plurality of mobile subnets and an Internet, the mobile subnets being connected to each other through the internet, comprises: each mobile subnet including an access router, a plurality of mobile nodes, and a plurality of regression agents; the regression agents arranged in a distributed topology structure; the regression agents exchanging information with each other by performing a broadcast of traffic load information (table) among the regression agents; and each of the regression agents having a traffic load table to perform a load balance operation accordingly.

In the aforementioned mobile IPv6 network having multiple distributed regression home agents, the traffic load table records a traffic load level of all regression agents and comprises information of a regression agent address, a traffic load, and a registered mobile node number. Each of the regression agents always monitors its traffic load and registered mobile node number. Each regression agent periodically broadcasts the traffic load information to the other regression agents; once receiving the traffic load information broadcasted by other regression agents, the regression agent timely updates its traffic load table. In each regression agent, when registering a mobile node, a corresponding timer starts clocking and a binding time of the current registration is stored into a update binding buffer; after the timer exceeds the binding time, i.e., the timer of the corresponding mobile node is time out, a reassignment of regression agent is performed to the mobile node. When the reassignment of regression agent is confirmed, by using a dynamic regression agent address discovery mechanism DHAAD, the regression agent actively sends an ICMP response information packet to the mobile node, wherein the ICMP response information packet is different from a standard ICMP response datagram and this ICMP response information packet can only have newly selected regression agent information, not including table information of the regression agent. After the mobile node receives the ICMP response information packet, the mobile-node compares a new regression agent and its old regression agent; if the new regression agent is different from the old regression agent, the mobile node modifies its regression agent and simultaneously sends binding update information to the new regression agent. According to an IPv6 protocol, the traffic load information of the broadcast is based on unsolicited router broadcast information in the IETF neighbor discovery protocol, that is, by setting a new option and a traffic load, the traffic load information is embedded into an optional region of the unsolicited router broadcast information.

A load balance method for multiple regression home agents according to the present invention comprises the steps of: (S1) determining whether a load is larger than a threshold or not, and executing Step S2 if a determined result is “YES” and executing Step S3 if the determined result is “NO”; (S2) determining whether there is a “LIGHT” regression agent or not; executing Step S4 if a determined result is “YES” and executing Step S5 if the determined result is “NO”; (S3) determining whether the registered mobile node number in all “LIGHT” regression agents is top 10% or not, and executing Step S8 if a determined result is “YES” and executing Step S7 if the determined result is “NO”, execute Step S7; (S4) randomly selecting one of the “LIGHT” regression agents and returning; (S5) determining whether the registered mobile node number in non-“LIGHT” regression agents is top 10% or not, and executing Step S6 if a determined result is “YES” and executing Step S7 if the determined result is “NO”; (S6) randomly selecting one of bottom 10% regression agents in the non-“LIGHT” regression agents and returning; (S7) performing no handoff operation of the regression agent and returning; (S8) randomly selecting one of bottom 10% regression agents in all “LIGHT” regression agents and returning.

### BRIEF DESCRIPTION OF THE DRAWINGS

FIG. 1 is a schematic diagram showing a mobile IPv6 network having multiple distributed regression home agents according to the present invention, in which a triangle routing communication situation is shown.

FIG. 2 is a schematic diagram showing a mobile IPv6 network having multiple distributed regression home agents according to the present invention, in which a situation of traffic load-broadcast is performed among the multiple regression home agents.

FIG. 3 is a diagram showing an example of a distributed regression agent topology structure and a traffic load table described in the network of FIG. 2.

FIG. 4 is a flow chart of a load balance method for multiple regression home agents according to the present invention.

FIG. 5 is a simulation result under a test using the load balance method for multiple regression home agents according to the present invention.

### DESCRIPTION OF THE PREFERRED EMBODIMENTS

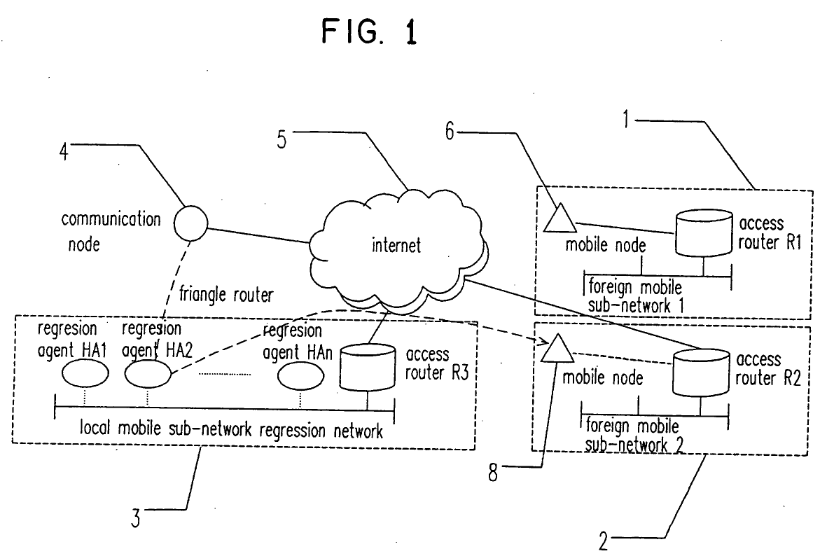

FIG. 1 is a schematic diagram of a mobile IPv6 network having multiple distributed regression home agents according to the present invention. In the IPv6 network, a number of mobile subnets (1, 2 and 3) are connected via the Internet. Assuming the mobile subnet (1) is a local mobile subnet of a mobile node (8), and the mobile subnet (1) is a regression network of the mobile node (8). In general, a mobile subnet comprises an access router, an agent server, and a number of mobile nodes. According to the mobile IPv6 network of the present invention, each mobile subnet comprises an access router, a number of agent servers, and a number of mobile nodes. For example, in the regression network (8), there are many regression agents (HA1, HA2, . . . n). These regression agents (HA1, HA2, . . . n) are arranged according to a distributed topology structure, and are equal to each other. When the mobile node (8) is just away from the regression network (8), the communication between a communication node (4) of calling the mobile node (8) and the mobile node (8) is performed by a triangle router through the regression network (8).

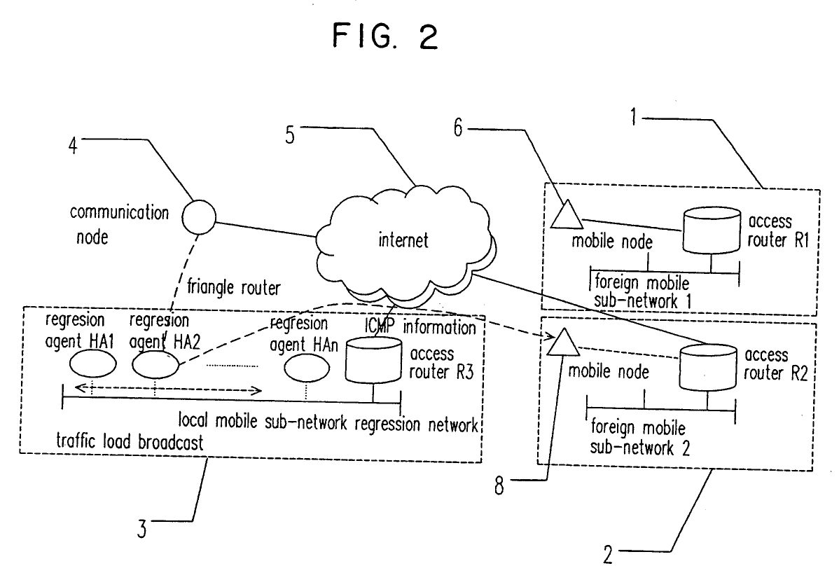

FIG. 2 is a schematic diagram showing a mobile IPv6 network having multiple distributed regression home agents according to the present invention, and shows a situation of a traffic load broadcast among the regression agents. Since the aforementioned regression agents are arranged based on the distributed topology structure, these regression agents (HA1, HA2, . . . , n) should be organically connected to form high performance and coordinate organism in order to reasonably and efficiently distribute loads. Therefore, the broadcast of the traffic load information (table) is performed among the regression agents, i.e., information is exchanged with each other. Each regression agent can balance load according to the traffic load information.

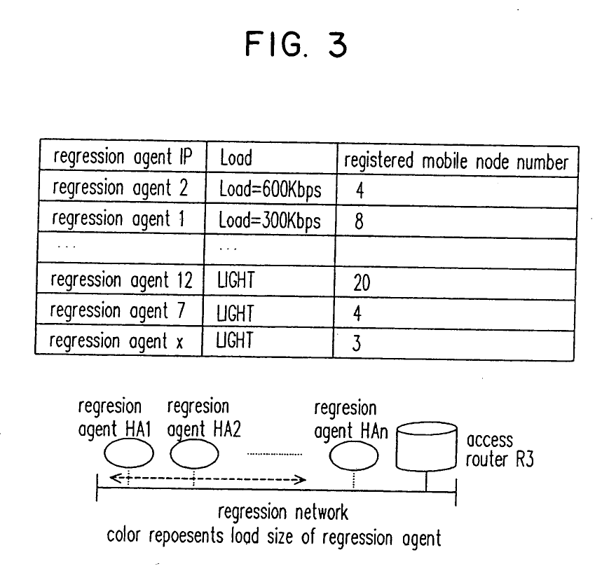

In order to obtain and maintain the traffic information, each regression agent maintains a so-called traffic load table (see FIG. 3). The traffic load table records traffic levels of all regression agents.

FIG. 3 shows an actual example of a traffic load table. Regression agent IP address information of the regression agent, load of the regression agent, and number of mobile nodes registered at the regression agent are regions of the traffic load table. The table shows the load and the number of the registered mobile nodes of each regression agent (HA1-HAn) at one particular time.

Each region of the traffic load table will be described in detail as follows.

1. Agent Address

The regression agent address is an IP address of the regression agent.

2. Queue Size

The traffic load indicates a buffer size of a regression agent. When the buffer size of the regression agent is lower than a threshold, the buffer size is considered as “LIGHT”.

3. Registered Mobile Node Number at Regression Agent

The regression agent should monitor the queue size and the registered mobile node number. Each regression agent periodically broadcasts traffic load broadcast information to all the other regression agents in the regression network. The traffic load broadcast information has the same regions as those in the traffic load table.

According to the IPv6 protocol, this broadcast information is based on unsolicited router broadcast information in the IETF neighbor discovery protocol. By setting a new option and a traffic load, the new option can be embedded into the optional regions of the unsolicited router broadcast information. This option region is as follows.

Queue Size (1 byte): a coarse parameter for the queue size in the router TLT.

Registered mobile node number (1 byte): If more than 256 mobile nodes are registered, the region will be a coarse parameter in the router TLT.

The unsolicited router broadcast information should be broadcasted based on a time interval parameter [MinRtrAdvInterval] defined by IETF RFC 2461. In order to update traffic information in time, the unsolicited router broadcast information with traffic load information should be sent within a time interval [MinRtrAdvInterval, MinRtrAdvInterval+IntervalTLTExtetension].

Here, IntervalTLTExtetension=2*MinRtrAdvInterval.

Once the traffic load broadcast information is received from other regression agent, the regression agent should record the information into the traffic load table. The regression agent sorts traffic load information in the traffic load table in a descendent order. The regression agent table is mainly sorted in a descendent order except that the traffic load is “LIGHT”. For the “LIGHT” regression agent, the traffic load table is sorted in the descendent order according to the registered mobile node number.

In the present invention, the queue size is used to determine and reset the regression agent. The registered mobile node number can prevent the traffic load bottleneck from occurrence.

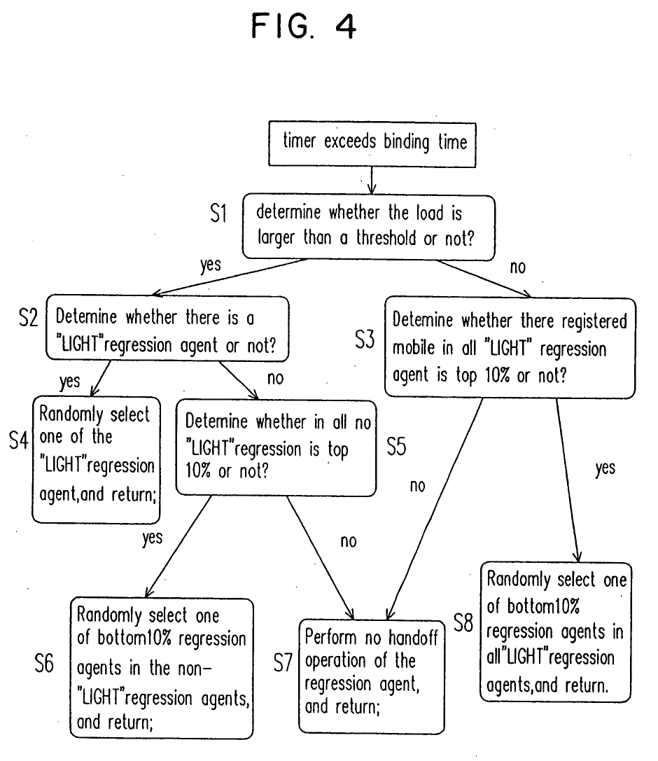

FIG. 4 is a flow chart of a load balance method for multiple regression home agents according to the present invention. This method can determine whether or not a new regression agent should be selected to balance the load.

The load balance method for multiple regression home agents according to the present invention will be described in detail below. Namely, how to perform a load balance among the multiple regression home agents according to the mobile IPv6 network having multiple distributed regression home agents will be described.

In the load balance method for multiple regression home agents according to the present invention, it mainly solves an issue of load balance and distribution among the multiple regression home agents. This method considers how to solve and prevent the traffic bottleneck from occurrence by considering tunnel traffic information and registered mobile node number information at each regression agent. The method proposed by the present invention can be implemented by embedding DHAAD defined by the mobile IPv6 standard, and can prevent the traffic load bottleneck from occurring in advance.

Since the multiple regression home agents in the mobile IPv6 network having multiple distributed regression home agents according to the present invention are arranged in a distributed manner, all of the regression agents can determine whether or not a handoff occurs. In the current technology, only a central dispatch system can determine whether or not a handoff can be performed. Therefore, the central dispatch system is not suitable for the regression agent. Since the central dispatch system needs to handle information of all the mobile nodes, it might become a traffic bottleneck as the mobile node number increases greatly.

In the mobile IPv6 network having multiple distributed regression home agents according to the present invention, the regression network is composed of a number of regression agents of the mobile IPv6 and a number of mobile nodes. When the mobile node stays at the regression network, the regression agent does not execute any task of the regression agent. When initializing the regression network, the registered mobile nodes of the regression agents in the regression network can be evenly disposed or unevenly disposed. Whether the regression agents are evenly disposed or not will not affect an initial traffic load and the ability of the above-mentioned load balance method.

In each regression agent, a timer and a binding update buffer region are combined. When registering a mobile node, the timer starts clocking and a binding time of the current registration is stored into the binding update buffer region. When the timer exceeds the binding time, i.e., when the timer of the corresponding mobile node is time-out, the mobile node performs an reassignment of the regression agent. Namely, the regression agent selects a new regression agent from the traffic load table. If a new regression agent is assigned to the aforementioned time-out mobile node, the regression agent actively sends ICMP response information packet to the mobile node and the mobile node does not require sending ICMP request information. The aforementioned ICMP response information packet is different from a standard ICMP response datagram. The ICMP response information packet can have only the newly selected regression agent, not including the regression agent table, so that the data transmission amount in the network is reduced. Upon receiving the ICMP information, the aforementioned time-out mobile node compares the received regression agent and its old regression agent. If the regression agent indicated by the above ICMP response information packet is different from the old regression agent, the mobile node will modify its regression agent and send binding update request information to the new regression agent at the same time. By using ICMP information defined by the DHAAD, the present invention can be implemented together with the IETF mobile IPv6 standard without any change of the protocol.

For the mobile node, the frequency of modifying the new regression agent is a tradeoff between the handoff of the regression agents and the load balance performance. The regression agent should not frequently select a new regression agent for the registered mobile node. Because the handoff of the regression agent will bring an additional traffic control and delays for the normal traffic communication of the mobile node, only a very busy mobile node or a potentially very busy mobile node processes the handoff of the regression agent.

If a new regression agent is to be selected, this regression agent should be the most released regression agent in the traffic load table. Two regions in the traffic load table can be used to perform a selection algorithm. One is the queue size, used to indicate the current traffic load; and the other one is the registered mobile node number, used to indicate a potential traffic load in the future. The regression agent should be prevented from having too many registered mobile node numbers, so that the future tunnel traffic load bottleneck can be prevented from being formed.

Referring to FIG. 4, the load balance method for multiple regression home agents according to the present invention is implemented as follows.

Once a timer corresponding to a certain mobile node exceeds the binding time, the regression agent corresponding to the mobile node processes operations in the steps of:

(S1) determining whether a load is larger than a threshold or not, and executing Step S2 if the determined result is “YES” and executing Step S3 if the determined result is “NO”;

(S2) determining whether there is a “LIGHT” regression agent or not, and executing Step S4 if the determined result is “YES” and executing Step S5 if the determined result is “NO”;

(S3) determining whether the registered mobile node number in all “LIGHT” regression agents is top 10% or not, and executing Step S8 if the determined result is “YES” and executing Step S7 if the determined result is “NO”;

(S4) randomly selecting one of the “LIGHT” regression agents and returning;

(S5) determining whether the registered mobile node number in all non-“LIGHT” regression agents is top 10% or not, and executing Step S6 if the determined result is “YES” and executing Step S7 if the determined result is “NO”;

(S6) randomly selecting one of bottom 10% regression agents in the non-“LIGHT” regression agents and returning;

(S7) performing no handoff operation of the regression agent and returning; and

(S8) randomly selecting one of bottom 10% regression agents in all the “LIGHT” regression agents and returning.

The above description describes the mobile IPv6 network having multiple distributed regression home agents and the load balance method for the multiple regression home agents. In the reselection algorithm of the regression agent, only the most busy regression agent can select a new regression agent for its registered mobile nodes. Therefore, the reassignment for a new regression agent does not take place frequently. When the mobile node moves from one network to another network, in the IETF mobile IPv6, the mobile node asks the regression agent to work for its tunnel data traffic before the communication node binding registration. Therefore, a regression agent having many registered nodes may have a large amount of triangle router tunnel data. The method of the present invention can perform a reselection operation of the regression agent under the condition that a large amount of traffic is crowded at the regression agent, so that the phenomenon of traffic load bottleneck in the feature can be prevented in advance.

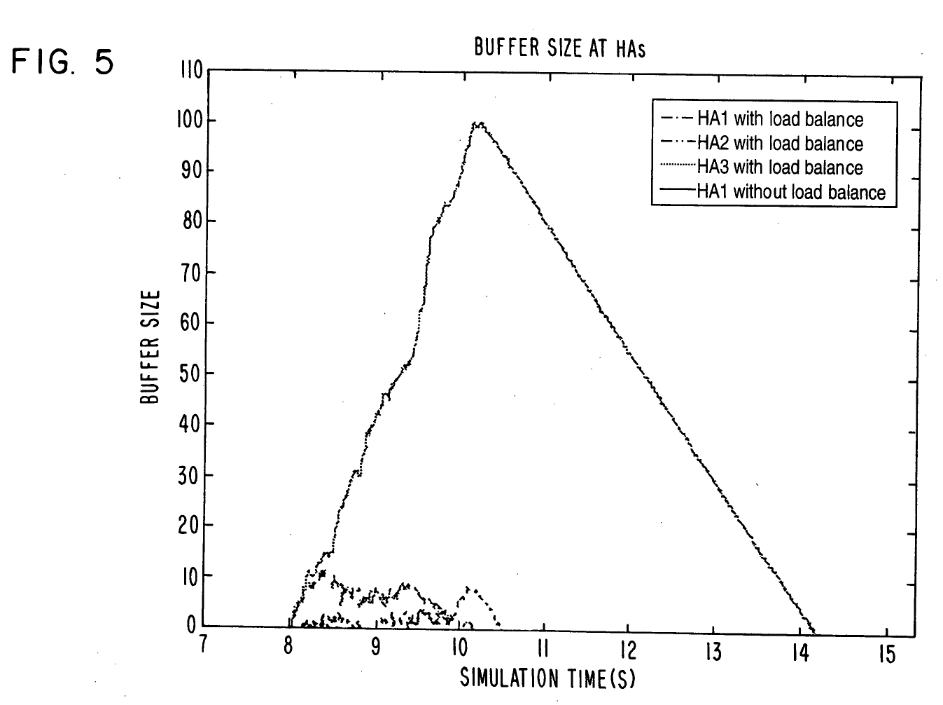

The simulation result of the present invention shows that the present invention can reduce the traffic delays significantly and the buffer requirement when the triangle router tunnel transmits data. FIG. 5 shows the queue size of the process queue at each regression agent with and without the traffic load balance method. The result shows the present invention can use multiple regression agents to share the traffic loads according to the queue size and the registered mobile node number when the regression agent reaches a saturated traffic situation.

1. A mobile IPv6 network having multiple distributed regression home agents, which includes a plurality of mobile subnets and an Internet, the mobile subnets being connected to each other through the Internet, the mobile Ipv6 network comprising:
each mobile subnet including an access router, a plurality of mobile nodes and a plurality of regression agents;
the regression agents arranged in a distributed topology structure;
the regression agents exchanging information with each other by performing a broadcast of traffic load information (table) among the regression agents; and
the regression agents each having a traffic load table to perform a load balance operation accordingly.

2. The mobile IPv6 network having multiple distributed regression home agents according to claim 1,
wherein the traffic load table records a traffic load level of all the regression agents, and comprises information of a regression agent address, a traffic load, and a registered mobile node number.

3. The mobile IPv6 network having multiple distributed regression home agents according to claim 1 or 2,
wherein each of the regression agents always monitors its traffic load and registered mobile node number.

4. The mobile IPv6 network having multiple distributed regression home agents according to claim 1 or 2,
wherein each regression agent periodically broadcasts the traffic load information to the other regression agents, and once receiving the traffic load information broadcasted by the other regression agents, the regression agent timely updates its traffic load table.

5. The mobile IPv6 network having multiple distributed regression home agents according to claim 4,
wherein, in each regression agent, when registering a mobile node, a corresponding timer starts clocking, and a binding time of the current registration is stored into a update binding buffer, and after the timer exceeds the binding time, i.e., after the timer of the corresponding mobile node is time out, a reassignment of the regression agent is performed to the mobile node.

6. The mobile IPv6 network having multiple distributed regression home agents according to claim 4,
wherein, when the reassignment of the regression agent is confirmed, by using a dynamic regression agent address discovery mechanism DHAAD, the regression agent actively sends an ICMP response information packet to the mobile node, in which the ICMP response information packet is different from a standard ICMP response datagram, and this ICMP response information packet comprises only newly selected regression agent information, not including table information of the regression agent.

7. The mobile IPv6 network having multiple distributed regression home agents according to claim 6,
wherein, after the mobile node receives the ICMP response information packet, the mobile node compares a new regression agent and its old regression agent, and if the new regression agent is different from the old regression agent, the mobile node modifies its regression agent and simultaneously sends binding update information to the new regression agent.

8. The mobile IPv6 network having multiple distributed regression home agents according to claim 6,
wherein, according to an IPv6 protocol, the traffic load information of the broadcast is based on unsolicited router broadcast information in the IETF neighbor discovery protocol, that is, by setting a new option and a traffic load, the traffic load information is embedded into an optional region of the unsolicited router broadcast information.

9. A load balance method for multiple regression home agents, comprising the steps of:
(S1) determining whether a load is larger than a threshold or not, and executing Step S2 if a determined result is “YES” and executing Step S3 if the determined result is “NO”;
(S2) determining whether there is a “LIGHT” regression agent or not, and executing Step S4 if a determined result is “YES” and executing Step S5 if the determined result is “NO”;
(S3) determining whether the registered mobile node number in all “LIGHT” regression agents is top 10% or not, and executing Step S8 if a determined result is “YES” and executing Step S7 if the determined result is “NO”;
(S4) randomly selecting one of the “LIGHT” regression agents and returning;
(S5) determining whether the registered mobile node number in non-“LIGHT” regression agents is top 10% or not, and executing Step S6 if a determined result is “YES” and executing Step S7 if the determined result is “NO”;
(S6) randomly selecting one of bottom 10% regression agents in the non-“LIGHT” regression agents and returning;
(S7) performing no handoff operation of the regression agent and returning; and
(S8) randomly selecting one of bottom 10% regression agents in all the “LIGHT” regression agents and returning.
